(19) United States
(12) Patent Application Publication
(10) Pub. No.: US 2009/0126712 A1
(43) Pub. Date: May 21, 2009

(54) Stone Saw Blade

(75) Inventors: Jorg H. Kullmann, Spangenberg (DE); Werner Kwanka, Vellmar (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WIKUS-Sagenfabrik Wilhelm H. Kullmann GmbH & Co. KG, Spangenberg (DE)

(21) Appl. No.: 12/269,983

(22) Filed: Nov. 13, 2008

(30) Foreign Application Priority Data
Nov. 15, 2007 (DE) 10 2007 054 601.9

(51) Int. Cl. B28D 1/08; B28D 1/12

(52) U.S. Cl. 125/21; 125/22

(57) ABSTRACT

A stone saw blade (1) includes an elongated base body (2) and a plurality of teeth (3). The teeth (3) are designed and arranged to be unset and to include geometrically defined cutting portions (11). The teeth (3) include a form body (4) being connected to the base body (2). The form body (4) includes a carrier (21) being made of hard metal and a layer (5) forming the cutting portion (11). The layer (5) has a hardness of at least 5,000 HK.

### CROSS REFERENCE TO RELATED APPLICATIONS

This application claims priority to co-pending German Patent Application No. DE 10 2007 054 601.9 entitled “Sägeblatt mit einem Grundkörper und Zähnen mit Schneiden”, filed Nov. 15, 2007.

### FIELD OF THE INVENTION

The present invention generally relates to a saw blade including an elongated base body and unset teeth having geometrically defined cutting portions. The teeth include form bodies being made of hard metal being connected to the base body.

The saw blade is designed to have an elongated base body, meaning it is designed as a saw band. The elongated base body includes seats serving for arrangement of form bodies being made of hard metal. Usually, these seats are produced on the elongated base body by milling. The form bodies made of hard metal are manufactured as separate elements, and they are afterwards permanently connected to the elongated base body on the seats. The form bodies made of hard metal include cutting portions of a geometrically defined shape, and they form the teeth of the saw blade.

### BACKGROUND OF THE INVENTION

A saw blade is known from German Patent Application No. DE 42 00 423 A1 corresponding to U.S. Pat. Nos. 5,477,763 and 5,425,296. The known saw blade serves for cutting metal. It includes a base body including unset teeth having cutting portions, the teeth being arranged in repeating cycles. The teeth may be made of form bodies being made of hard metal and being connected to the base body. Each cycle includes at least a group of teeth including at least three teeth, the group of teeth including teeth of different heights and widths. All teeth are designed to be symmetric with respect to the longitudinal center plane extending through the base body. The teeth include geometrically defined cutting portions, meaning each tooth includes its own geometrically defined shape including a rake angle, a clearance angle, and so forth. The effective cutting portions of all teeth are each formed by a cutting edge the inner section of which extends approximately perpendicular to the longitudinal center plane. Bevels being declined towards the base body are arranged next to the inner section in a symmetric arrangement. In this way, the cutting edge includes corners in the region of the deviated cutting edge as well as in the transition region between the bevel and the flank. The shape of the cutting edges at each tooth may be changed by increasing the number of the deviation points. The shape of the cutting edges may be changed by increasing the number of deviation points such that one theoretically attains a rounded cutting edge when using an infinite number of deviation points.

Another saw blade is known from German Patent Application No. DE 199 63 396 A1 corresponding to US Patent Application No. US 2001/0004860 A1. The known saw blade is used for cutting metal. The number of tooth in one cycle is at least two. The teeth may be formed by form bodies of hard metal being connected to the base body. The two teeth form a first group of teeth, and they are designed and arranged to have different heights and widths. An effective cutting edge in the form of a deviated line is formed at each tooth. There is a second group of teeth, the teeth having straight continuous cutting edges extending over the width. The teeth of the second group of teeth are designed to be identical. The teeth of the second group of teeth are the teeth having the greatest width and the smallest height. The teeth of the first group of teeth and of the second group of teeth may be arranged in an alternating way.

Another saw blade is known from German Patent Application No. DE 44 23 434 A1 corresponding to U.S. Pat. No. 6,314,854 B1. Various embodiments of saw blades are shown in this document. The common feature of all embodiments is the fact that the flanks of the teeth have a convex arc-like shape. The configuration of the teeth according to FIG. 1 is such that the saw blade includes a base body and unset teeth being symmetric to a longitudinal center plane through the base body. The teeth all have the same design, and they are arranged on the base body without a repeating group of teeth. The effective cutting edges and portions of the cutting edges, respectively, of all teeth are all formed by a deviated cutting edge of a straight portion. The inner portion of the straight portion is located approximately perpendicular to the longitudinal center plane. A bevel being declined in an outer direction towards the base body is connected to the inner portion. Thus, the cutting edge includes corners in the region of the deviated cutting edge as well as in the transition region between the face and the flank. Another embodiment illustrated in FIGS. 2 and 3 is a saw blade including a base body and unset teeth which are arranged to be non-symmetric to a longitudinal center plane through the base body. The teeth are located in a repeating group of teeth, each group of teeth including two teeth. The cutting edges of these teeth are designed in the sense of a leading tooth and a trailing tooth. The teeth are eccentrically subjected to forces during sawing as this is the case in a similar way when using said teeth. The teeth are designed and arranged in a non-symmetric way. The non-symmetric structure of two adjacent teeth is realized in a mirror-inverted way with respect to the longitudinal center plane. The cutting edges are designed to be hyperbolic or parabolic. It is desired that the transition between the cutting edge and the flank is smoothed. Such saw blades are especially used for sawing plastic in a way to realize minimum sawing lines and to also minimize breaking effects of the corners of the material to be cut.

It is also generally known to cut stone, especially granite, sandstone, marble and the like, by sawing elements having geometrically undefined cutting portions. For example, rope saws are known in which a circulating rope is used, the rope including cylinder-shaped segments, the segments including a cover made of diamonds. Such rope saws only supply low cutting power, they can only be operated with a comparatively small feed, and they produce a comparatively wide cutting channel in the stone such that there is a great loss of material during cutting. The producible cuts are often not straight, and they are comparatively rough at the cutting surface.

It is also generally known to use abrasive cutoff wheels having a comparatively great diameter. Such known cutoff wheels supply advantageous cutting power, but they disadvantageously result in a respectively wide cutting channel being produced in the stone to be cut.

It is also generally known that horizontal frame saws are used for cutting stone, these frame saws generally having the design and arrangement as it is known from frame saws for cutting wood. The saw blades of the known frame saws include a cover made of diamonds such that there are geometrically undefined cutting portions. Drawbacks of such known frame saws are the low flexibility and the great thickness of the discs resulting from the design of the saw.

A tool for producing channels and grooves by milling is known from European Patent Application No. EP 0 590 408 A1. This document only teaches the design of a milling cutter. This document does not relate to the design of a saw blade.

A saw blade is known from European Patent Application No. EP 715 919 A1 and corresponding European Patent No. EP 0 715 919 B1. This document teaches a positive engagement of an insert of the saw blade in the base body by a clamping or plugging connection. The insert may have a surface hardness of at least 1,200 HV 30.

A drill is known from German Patent Application No. DE 196 52 208 A1. This document relates to a drill, especially a drill for drilling holes in hard material, as for example stone. This document does not relate to the design of a saw blade.

### SUMMARY OF THE INVENTION

The present invention relates to a stone saw blade. The stone saw blade includes an elongated base body and a plurality of teeth. The teeth are designed and arranged to be unset and to include geometrically defined cutting portions. The teeth include a form body being connected to the base body. The form body includes a carrier being made of hard metal and a layer forming the cutting portion. The layer has a hardness of at least 5,000 HK.

It is to be understood that the present specification and claims relate to a cutting portion of a geometrically defined shape. This is a technical term as defined in German standard DIN 8580 which defines cutting-off methods removing chips and using a cutting portion of a geometrically defined shape as turning on a lathe, drilling, milling, planing, broaching, sawing and filing. In contrast thereto, cutting-off methods removing chips using a cutting portion of a geometrically undefined shape are defined as grinding, honing and lapping, for example.

The novel layer is substantially harder than the carrier of the form body. The carrier is made of hard metal. The form bodies form the teeth of the saw blade, and they have a geometrically defined shape including a cutting portion, a cutting edge, a rake angle, a clearance angle, and so forth. It is sufficient if the layer being located on the form bodies being made of hard metal is comparatively thin. It is important that the layer has an extremely great hardness which is only achieved by few materials. Especially, the layer may be made of polycrystalline diamond (PCD) or cubic boron nitride (CBN). The use of such materials on saw blades is new, and it results in outstanding cutting results when sawing stone with the novel stone saw blade. For this purpose, the layer has a hardness of at least 5,000 HK (Knoop hardness). For low loads, the Knoop hardness approximately corresponds to the Vickers hardness (HK˜HV).

The layer may be arranged at the surface of the carrier of the form body facing towards the front as seen in the direction of movement of the saw blade during sawing. The layer forms a face at least partly being contacted by the material to be removed and the material which has already been removed. This also applies to the cutting edge of the face. The use of this layer having an extremely great hardness in combination with the design of the carrier leads to the desired effect when sawing stone that there rather is a beating or hammering action instead of a cutting removal of chips. During this beating or hammering action, small portions of the stone are smashed and shattered, and they are removed in this way. The layer also acts as a protective layer for the carrier of the form body and thus preventing wear and tear of the tooth.

It is preferred if at least the part of the face of the layer contacting the stone has a round or rounded cutting edge (as to be seen in a direction against the direction of movement of the saw blade, see the illustration of FIG. 2). This applies at least to one tooth of a group of teeth, and preferably to all teeth of the saw blade. It is preferred not to use deviated cutting edges as they are known in the prior art. Consequently, there are no corners or sharp deviation points in the region of the cutting edge. This especially applies to the transition region between the cutting edge and the rear free surface, but also to the transition region to the flank surfaces of the tooth. The round shape prevents undesired corners. The round shape may be one including a plurality of arc pieces being connected to each other. The arc pieces may have different radiuses. However, it is also possible that the cutting edge simply has a circular design.

The form body including the carrier being made of hard metal and the layer having a great hardness may be positively engaged in a seat of the elongated base body, the seat being produced by milling. The positive engagement at least relates to the radial direction and the tangential direction. The permanent connection between the form body made of hard metal and the elongated base body may be realized by connecting methods such as welding, soldering, brazing, and the like.

The cutting portions of a geometrically defined shape of the novel saw blade for sawing, cutting and separating, respectively, stone material may additionally have the features and advantages known from applicant's German Patent Application No. DE 42 00 423 A1 corresponding to U.S. Pat. No. 5,477,763 and U.S. Pat. No. 5,425,296 and/or German Patent Application No. DE 199 63 396 A1 corresponding to US Patent Application No. US 2001/0004860 A1. This relates both to the use of a variable division and the arrangement of different teeth in repeating cycles. Preferably, each cycle at least includes one group of teeth including at least three teeth having different heights and widths. Preferably, the height of adjacent teeth is reduced, while the widths of the same adjacent teeth are increased. It is also possible to use a plurality of group of teeth in an intermittent arrangement on the base body. It is preferred that at least the teeth of one group of teeth have rounded cutting edges. Another group of teeth may also have rounded cutting edges while it only includes teeth of an identical shape in the group.

The teeth being formed by the form bodies may have a negative rake angle, especially a rake angle between approximately −25° and 0°. The clearance angle may be between approximately 0° and 15°. Such a clearance angle relates to the roof surface of a tooth and/or the design of the flanks.

However, it is also possible that the teeth being formed by the form bodies have a positive rake angle. In this case, they include a negative protecting bevel of approximately between 0° to −25°. In this way, the hammering destruction of the stone material during sawing is also realized in an advantageous way.

The face of the layer of each form body may include a coating of hard material. Especially, it is preferred to use aluminum titanium nitride, titanium aluminum carbon nitride or chrome nitride, and the like. The coating may also include a plurality of layers. Usually, the coating extends over the face as well as over the cutting edge and a part of the flanks of each form body.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a side view of a first exemplary embodiment of the novel saw blade.

FIG. 2 is a view of a portion of the tips of the teeth of the novel saw blade as seen in a direction against the direction of movement of the saw blade.

FIG. 3 is a side view of a first exemplary embodiment of a novel form body of.

FIG. 4 is a front view of the form body of FIG. 3.

FIG. 5 is a side view of a second exemplary embodiment of the novel saw blade.

### DETAILED DESCRIPTION

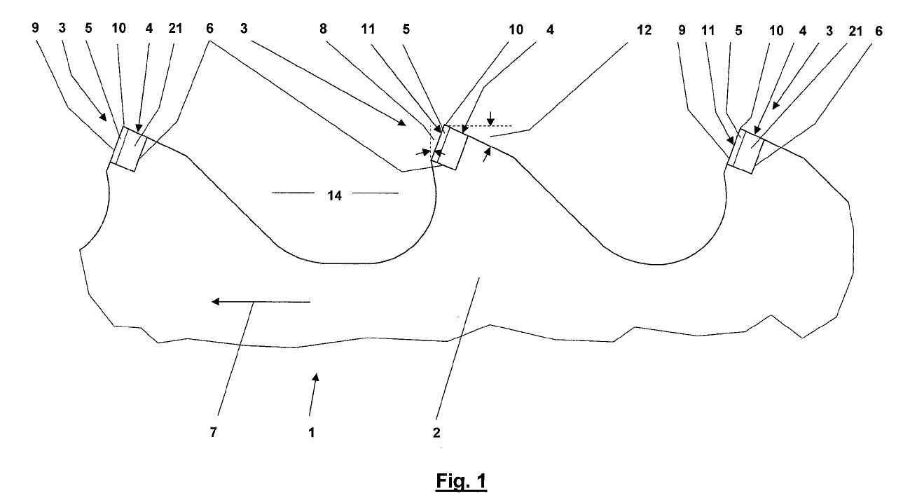

Referring now in greater detail to the drawings, FIG. 1 illustrates a side view of a first exemplary embodiment of a novel saw blade 1. The novel saw blade 1 is a stone saw blade 1. Only a part of the saw blade 1 is illustrated. The saw blade 1 includes an elongated base body 2 having a rectangular cross-section. The teeth 3 are arranged at one side of the base body 2. The teeth 3 are unset, and they are preferably designed and arranged to be symmetric with respect to the longitudinal center plane 14 of the base body 2. The teeth 3 have a width which is greater than the width of the base body 2.

The teeth 3 are partly formed by form bodies 4. Each form body 4 includes a carrier 21 being made of hard metal. Preferably, the greater part of the form body 4 is made of the carrier 21. At one side or surface, the form body 4 includes a layer 5 being made of a material which is even harder than the material of the carrier 21 of the form body 4, meaning harder than hard metal. The layer 5 has a Knoop hardness of at least 5,000 HK. Suitable materials having such an outstanding hardness are especially PCD (polycrystalline diamond) or CBN (cubic boron nitride). The layer 5 is permanently connected to the carrier 21.

The form bodies 4 including the layers 5 are fixedly located in seats 6. The seats 6 as well as the remaining shape of the elongated base body 5 at the side where the teeth 3 are located preferably are produced by milling. The form bodies 4 are permanently connected to the material of the base body 4 in the region of the seats 6, for example by welding, soldering or brazing. The seats 6 are designed in a way that each form body 4 is positively engaged in at least two directions being approximately perpendicular with respect to one another. Inserting the form body 4 is realized in a way that the layers 5 face in the direction of movement 7 of the saw blade 1.

It is also to be seen in FIG. 1 that the form bodies 4 forming the teeth 3 are arranged at a negative rake angle 8. The rake angles 8 of all teeth 3 may be identical. However, it is also possible that the negative rake angles 8 differ from one tooth 3 compared to another tooth 3 such that one attains groups of teeth 3 including, for example, three adjacent teeth 3, the negative rake angles 8 being repeated for the respective teeth 3 in each group. Especially, negative rake angles 8 between −25° and 0° are used.

It is also to be seen in FIG. 1 that the teeth 3 may be arranged at a variable division, meaning at different distances with respect to one another. The teeth 3 may also have different heights and/or widths. Each tooth 3 at the free surface of the layer 5 facing towards the front as seen in the direction of movement 7 includes a face 9 in its upper portion ending in a cutting edge 10. The upper portion of the face 9 and the cutting edge 10 together form a cutting portion 11. The form bodies 4 partly forming the teeth 3 are arranged at a clearance angle 12 such that there is a rear clearance surface at each tooth 3.

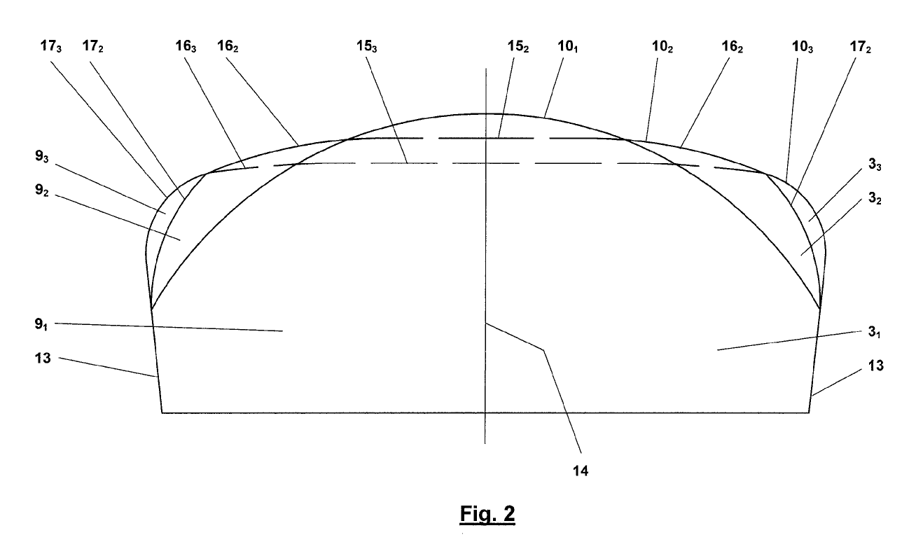

FIG. 2 illustrates the design of the regions of the cutting portions 11 of three teeth 3 in their projection against the direction of movement 7. A tooth 3₁ is to be seen which is followed by a second tooth 3₂ as seen against the direction of movement 7, the second tooth 3₂ being followed by a third tooth 3₃. It is to be seen that the group of teeth includes at least three teeth 3₁, 3₂, 3₃. This group is repeated in cycles. Each cycle includes at least one group, meaning at least three following teeth 3. However, other designs and arrangements of the teeth, the groups of teeth and the cycles are also possible.

It is also to be seen in FIG. 2 that the tooth 3₁ includes a face 9₁ in its upper end being connected to a cutting edge 10₁. The cutting edge 10₁ has a circular arc shape, and it is connected to a flank 13 at the right hand side and at the left hand side by an intermediate arrangement of a corner. The flanks 13 and the respective flank angles are identical for all teeth 3₁, 3₂ and 3₃, and they coincide in the projection.

The following tooth 3₂ includes a cutting edge 10₂. It is to be seen that the cutting edge 10₂ is a combination of a series of radiuses such that one attains the rounded shape illustrated in FIG. 2. In the middle portion, meaning next to the longitudinal center plane 14, the cutting edge 10₂ includes a straight piece 15₂ in which the radius is infinite. An arc section 16₂ is arranged next to the straight piece 15₂, the arc piece 16₂ having a finite radius. Each arc piece 16₂ is connected to another arc piece 17₂. The transition between the arc pieces 16₂ and 17₂ is preferably realized by a common tangent. The arc piece 17₂ is connected to the flank 13 almost without a deviation point.

The third tooth 3₃ in the group of teeth 3 also includes a rounded cutting edge 10₃. The cutting edge 10₃ includes a straight piece 15₃ and two arc pieces 16₃ and 17₃. The arc piece 17₃ is arranged in a way and it is determined by a radius chosen in a way such that it is connected to the flank 13 in a tangential direction. The transition point is located slightly below this point at which the tooth 3₃ has its greatest width. At least one of the teeth 3₁, 3₂ and 3₃ has such a shape as it has been described with respect to the tooth 3₃. However, it is also possible to design all teeth 3 in the group of teeth 3 in this way to prevent deviation points at the transitions to the flanks 13.

It is also to be seen in FIG. 2 that the teeth 3₁, 3₂ and 3₃ are designed and arranged to have different heights and widths. The tooth 3₁ is the tooth having the greatest height and the smallest width. The tooth 3₃ is the tooth having the smallest height and the greatest width. The tooth 3₂ lies in between the teeth 3₁ and 3₃. However, it is to be understood that the order of the teeth 3₁, 3₂ and 3₃ in the direction of movement 7 may also be different. The teeth 3₁, 3₂ and 3₃ may have the same or different rake angles 8. The clearance angle 12 at the rear of the teeth 3 may also differ. Each tooth 3₁, 3₂ and 3₃ preferably only cuts with its portion of the cutting edge 10 which freely protrudes in the projection according to FIG. 2. In this way, strips of material are removed from the cutting channel, as this has been described in the background section of the present application. Removing of the strips of material however does not occur chip by chip, but instead by a hammer-like destruction of material by the single strip-shaped portions of the stone material in the cutting channel being smashed and shattered.

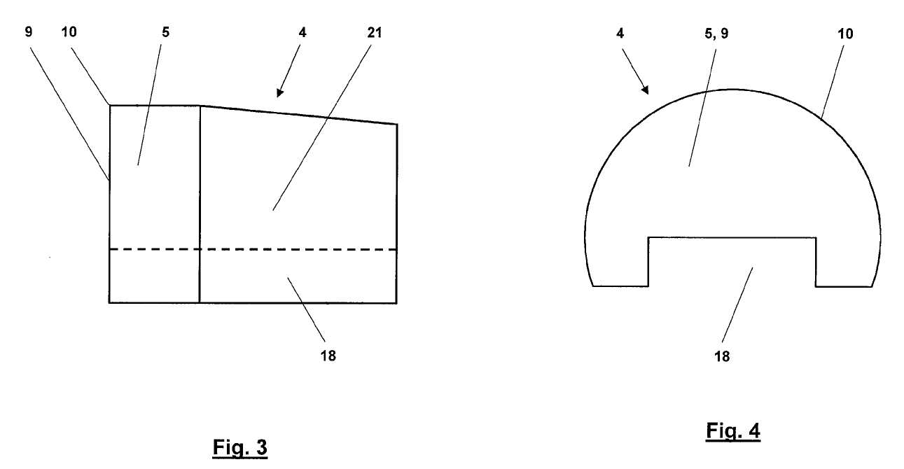

FIGS. 3 and 4 illustrate a preferred exemplary embodiment of the novel form body 4. The form body 4 includes the carrier 21 being made of hard metal. The carrier 21 at its one side being connected to the layer 5 being made of PCD (polycrystalline diamond) or CBN (cubic boron nitride). The layer 5 is thinner, usually substantially thinner, than the carrier 21 of the form body 4. The form body 4 with the free surface of the layer 5 forms the face 9. The face 9 at its upper end is connected to the cutting edge 10. According to the exemplary illustration of FIG. 4, the cutting edge 10 is designed to have an arcuate shape. The form body 4 in its lower portion includes a recess 18 and a channel, respectively, the width of which corresponds to the thickness of the elongated base body 2. Considering the design and arrangement of the seats 6 in combination with the recess 18, it is clear that each form body 4 in all three directions is fixedly located in a defined and positively engaged way on the base body 2.

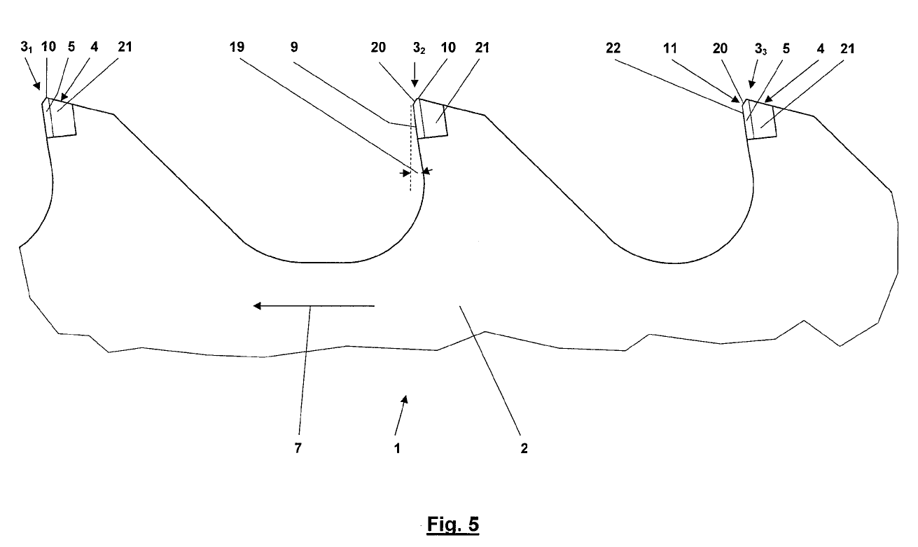

FIG. 5 illustrates another exemplary embodiment of the saw blade 1 including the base body 2 and three teeth 3₁, 3₂ and 3₃ being located in one group of teeth 3. It is to be understood that the number of teeth 3 in the group of teeth may also be smaller or greater than three. In this case, the teeth 3₁, 3₂ and 3₃ are arranged at a positive rake angle 19. The rake angle 19 of the single teeth 3₁, 3₂ and 3₃ may be chosen to be identical or to be different. The same applies to the division of the saw blade 1, meaning to the distances between the teeth 3. Each face 9 of the layer 5 being located at a positive rake angle 19 in its upper portion is connected to a negative protecting bevel 20. The cutting edge 10 is located at the highest locations of the protecting bevel 20. The protecting bevel 20 extends within the layer 5. Due to the protecting bevel 20, one also attains a negative angle in the region of the cutting edge 10 such that the desired hammering and smashing effect of the cutting elements 11 with respect to the stone material also becomes possible.

It is possible to arrange a hard material coating 22 in the regions of the surface 9 and/or the protecting bevel 20 including the cutting edge 10 of the layer 5. For reasons of clarity of the drawings, this is only illustrated at one tooth 33 in FIG. 5. However, it is to be understood that the other teeth 3 may also include such a hard material coating 22. The hard material coating 22 may also extend over a part of the flanks 13 of the teeth 3. The hard material coating 22 may be especially aluminum titanium nitride, titanium aluminum carbon nitride or chrome nitride.

Many variations and modifications may be made to the preferred embodiments of the invention without departing substantially from the spirit and principles of the invention. All such modifications and variations are intended to be included herein within the scope of the present invention, as defined by the following claims.

We claim:

1. A stone saw blade, comprising:
an elongated base body; and
a plurality of teeth,
said teeth being designed and arranged to be unset and to include geometrically defined cutting portions,
said teeth including a form body, said form body being connected to said base body,
said form body including a carrier being made of hard metal and a layer forming said cutting portion, said layer having a hardness of at least 5,000 HK.

2. The stone saw blade of claim 1, wherein said layer is made of at least one of the materials selected from the group consisting of PCD and CBN.

3. The stone saw blade of claim 1, wherein said layer forms a face of said form body.

4. The stone saw blade of claim 2, wherein said layer forms a face of said form body.

5. The stone saw blade of claim 3, wherein at least a part of said face of said layer includes a round cutting edge.

6. The stone saw blade of claim 4, wherein at least a part of said face of said layer includes a round cutting edge.

7. The stone saw blade of claim 5, wherein said round cutting edge has a circular shape.

8. The stone saw blade of claim 6, wherein said round cutting edge has a circular shape.

9. The stone saw blade of claim 1, wherein said elongated base body includes a plurality of seats being produced by milling, said form body being designed and arranged to positively engage one of said seats.

10. The stone saw blade of claim 1, wherein said teeth are arranged on said base body in groups of teeth, said teeth having different heights and widths.

11. The stone saw blade of claim 1, wherein said teeth have a negative rake angle.

12. The stone saw blade of claim 11, wherein said rake angle is approximately between −5° and 0°.

13. The stone saw blade of claim 1, wherein said teeth are designed and arranged to have a clearance angle of approximately between 0° and 15°.

14. The stone saw blade of claim 1, wherein said teeth have a positive rake angle and include a negative protecting bevel having an angle of approximately between 0° and −25°.

15. The stone saw blade of claim 3, wherein said face includes a coating being made of hard material.

16. The stone saw blade of claim 15, wherein said hard material is selected from the group consisting of aluminum titanium nitride, titanium aluminum carbon nitride and chrome nitride.
